(19) United States
(12) Patent Application Publication
(10) Pub. No.: US 2003/0065604 A1
(43) Pub. Date: Apr. 3, 2003

(54) Methods and systems for measuring performance of a security analyst

(76) Inventor: Joseph Gatto, San Francisco, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/194,437

(22) Filed: Jul. 12, 2002

Related U.S. Application Data
(60) Provisional application No. 60/327,050, filed on Oct. 3, 2001.

(51) Int. Cl. G06F 17/60

(52) U.S. Cl. 705/36

(57) ABSTRACT

A computer implemented system for displaying security analyst recommendation information includes a database includes information on an overall analyst score. The overall analyst score has a value add that is obtained by subtracting a return of a benchmark portfolio from a return of a simulated portfolio return. The return of the benchmark portfolio is derived exclusively from a selected set of securities included in a set of securities covered by the analyst. The simulated portfolio includes constituents and weights that are a function of the analyst's recommendations on the securities in the selected set. A user interface is provided with a plurality of selectable user inputs. The user inputs enable a user to display analyst security recommendation information. An input device is included that is operable by a user. A display is provided for displaying at least one output of a security analyst information according to the selected user inputs.

### CROSS REFERENCE TO RELATED APPLICATIONS

This application claims the benefit of U.S. Ser. No. 60/327,050, filed Oct. 3, 2001, which application is fully incorporated herein by reference.

### BACKGROUND

1. Field of the Invention

This invention relates generally to systems, and their methods of use, that measure actual performance of a security analyst, and more particularly to systems, and their methods of use that measure performance of a security analyst's recommendations using a value add that is determined by subtracting a return of a benchmark portfolio from a return of a simulated portfolio return and then multiplied by an adjustment factor.

2. Description of the Related Art

Many individuals and institutions analyze financial data, financial instruments, such as equity and fixed-income securities, and other things, at least in part to predict future economic events. Such individuals may include, for example, security analysts. The role of the security analyst is generally well-known and includes, among other things, issuing earnings estimates or recommendations on whether investors should buy, sell, or hold financial instruments, such as equity securities, and other predictions. Security analyst estimates may include, but are not limited to, quarterly, semi-annual, and annual earnings estimates for companies whether or not they are traded on a public securities exchange.

For each security an analyst covers, the analyst issues a “recommendation” or “rating” on the security. This recommendation or rating on serves as a recommendation as to whether to own or weight, relative to a neutral baseline level, holdings of a particular security during a particular time period. Different entities use different language and sometimes different number of levels of recommendations.

Usually more than one analyst follows a given security. Analysts often disagree on earnings estimates and recommendations and, as a result, analysts' earnings estimates and recommendations often vary.

A number of financial information services providers (“FISPs”) gather and report analysts' earnings estimates and recommendations. At least some FISPs report the high, low, and mean (or consensus) earnings estimates, as well as mean recommendations for equity securities (as translated to an FISP's particular scale, for example, one to five). In addition, FISPs may also provide information on what the earnings estimates and recommendations were at historical points in time including, but not limited to seven and thirty days prior to the most current consensus, as well as the differences between the consensus (e.g., consensus growth or consensus P/E) for a single equity security and that of the relevant industry.

For some clients, FISPs provide earnings estimates and recommendations on an analyst-by-analyst basis. An advantage of the availability of analyst-level estimates and recommendations is that a client may view the components of the mean estimate or recommendation by analyst. FISP's also work with the employers of the analysts to standardize the firms ratings to a single scale.

One method for determining estimates utilizes a software program that displays all current estimates. For a selected fiscal period security, the software provides the ability to simply “include” or “exclude” each estimate or recommendation from the mean. This is problematic for several reasons. First, commercially available databases of estimates and recommendations contain “current” data on thousands of stocks. Each stock may have estimates from 1 to 70 or more analysts. In addition, each analyst may provide estimates for one or more periods. The data may be updated throughout the day. Manually dealing with this volume of information may be time consuming and tedious.

The actual performance of a security analyst relative to his recommendations on whether investors should buy, sell, or hold financial instruments has been measured by including various degrees of positive recommendations in the construction of a simulated portfolio of securities with these ratings. However, this method fails to address analyst performance on ratings at other levels.

Other methods and systems have utilized a two-tier system using a simulated portfolio calculation that employs a own securities rated positively or don't own securities not rated positively scheme. Additional methods have been utilized with overweight securities rated strong positive over securities rated positive.

Methods and systems to date that measure actual performance of a security analyst typically compare an analyst's security recommendation performance to a benchmark. The purpose of comparing to a benchmark is often to determine the extent to which the analyst's performance was due to his/her abilities versus the extent to which his/her performance was due to external factors. External factors can be the overall market performance and the performance of the types of business covered by the analyst. One approach for selecting a benchmark is to choose an industry group from a published industry scheme, such as Dow Jones, or Morgan Stanley Capital International, as a benchmark. In this case, a published industry group is chosen that corresponds to an industry covered by the analyst.

The published industry consists of a set of securities in related fields of business. The return of this set of securities as a whole is used as a benchmark against which to compare the analyst's performance. A problem with this approach is that industries in published industry grouping schemes vary in their homogeneity with respect to the securities in each grouping. Some industry groupings contain very similar securities or companies in similar lines of business, while others contain companies in widely varying types of business. This results in some securities covered by some analysts that aren't included in their main industry groups. Thus, stocks that fall outside of an industry category will not count toward the performance of that analyst in their main industry group. It also results in the inclusion in an analyst's benchmark portions of an industry group not covered by the analyst.

Current approaches for measuring the performance of security analyst fail to distinguish securities in a portfolio that are rated neutral from those rated negatively. Additionally, current methods and systems fail to incorporate analyst's ratings at levels other than positive and strong positive into the analyst's overall performance calculation. Additionally, existing benchmarks can introduce factors unrelated to the analyst coverage and do not always fully encompass the analyst coverage.

There is a need for methods and systems for measuring performance of a security analyst that distinguishes the treatment of securities rated neutral and those that are rated negatively. There is a further need for methods and systems for measuring performance of a security analyst that incorporate analyst ratings other than strong positive or positive into an overall analyst performance calculation. There is yet a further need for methods and systems for measuring performance of a security analyst that use benchmarks without introducing factors not directly related to the analyst coverage.

### SUMMARY

Accordingly, an object of the present invention is to provide computer implemented systems that are used to evaluate security analyst performances.

Another object of the present invention is to provide computer implemented systems that create benchmarks which are used to compare the recommendation performance of a security analyst.

Yet another object of the present invention is to provide computer implemented systems to evaluate security analyst performances that distinguish the treatment of securities with different ratings.

A further object of the present invention is to provide computer implemented systems to evaluate performance of security analysts utilizing a value add created by subtracting a return of a benchmark portfolio from a return of a simulated portfolio.

Still another object of the present invention is to provide computer implemented systems to evaluate performance of a security analyst utilizing a value add created by subtracting a return of a benchmark portfolio from a return of a simulated portfolio, where the return of the benchmark portfolio is derived exclusively from a selected set of securities included in the set of securities covered by the analyst.

A further another object of the present invention is to provide computer implemented systems to evaluate performance of a security analyst utilizing a value add created by subtracting a return of a benchmark portfolio from a return of a simulated portfolio, where the simulated portfolio includes constituents and weights that are a function of the analyst's recommendations on a selected set of securities.

Another object of the present invention is to provide computer implemented systems to evaluate security analyst performances that distinguish the treatment of securities rated neutral and those rated negatively.

Still another object of the present invention is to provide computer implemented systems that incorporate analyst ratings other than strong positive or positive into an overall analyst performance calculation.

Yet another object of the present invention is to provide computer implemented systems that use benchmarks without introducing factors not directly related to an analyst's coverage.

Another object of the present invention is to provide computer implemented systems that provide visual displays of an analysts overall performance.

Another object of the present invention is to provide computer implemented systems that provide visual displays of an analyst's performance for a single security.

A further object of the present invention is to provide computer implemented systems that evaluate security analyst performances for compliance and monitoring applications.

These and other objects of the present invention are achieved in a computer implemented system for displaying security analyst recommendation information. A database includes information on an overall analyst score. The overall analyst score has a value add that is obtained by subtracting a return of a benchmark portfolio from a return of a simulated portfolio return. The return of the benchmark portfolio is derived exclusively from a selected set of securities included in a set of securities covered by the analyst. The simulated portfolio includes constituents and weights that are a function of the analyst's recommendations on the securities in the selected set. A user interface is provided with a plurality of selectable user inputs. The user inputs enable a user to display analyst security recommendation information. An input device is included that is operable by a user. A display is provided for displaying at least one output of a security analyst information according to the selected user inputs.

In another embodiment of the present invention, a computer implemented system for displaying security analyst recommendation information has a database. The database includes information on an analyst's securities recommendation performance for a plurality of securities listed on a securities recommendation list. A user interface is provided with a plurality of selectable user inputs to enable a user to display analyst security recommendation information. A user interface includes a plurality of selectable user inputs that enable a user to display analyst security recommendation information. An input device is provided that is operable by the user. A display is included that simultaneously displays at least one output of the analyst's securities recommendation performance and an estimates performance for a plurality of securities listed on a securities estimates list of the analyst.

In another embodiment of the present invention, a computer implemented system for displaying security analyst recommendation information includes a database. The database has information on at least a portion of securities covered by an analyst. A user interface is provided with a plurality of selectable user inputs to enable a user to display analyst security recommendation information. An input device is operable by a user. A display is provided for displaying at least one output of a security analyst information according to the selected user inputs. The system provides a summary of an individual analyst's ratings for a security that is displayable as a chart with at least first and second time series plots. The first time series plot is representative of the analyst's recommendations over time. The analyst's recommendations are plotted against a vertical axis, representative of recommendation levels, and a horizontal axis that is representative of time. The second time series plots are representative of a price for the security over time. The price for the security is plotted against another vertical axis that is representative of security price, and the horizontal axis is representative of time.

In another embodiment of the present invention, a computer implemented system for measuring an analyst's security recommendation performance includes means for providing information on at least a portion of securities covered by an analyst. Means that provide a plurality of selectable user inputs are provided. These inputs enable a user to display analyst security recommendation information. Means for providing input by a user are included. Means for displaying at least one output of a security analyst information according to the selected user inputs are also provided.

### BRIEF DESCRIPTION OF THE DRAWINGS

FIGS. 1(a) through 1(c) are flow charts that illustrate one embodiment of methods and systems of the present invention that measure performance of one or more security analysts.

FIG. 2 is a screenshot illustrating the listing and displaying of individual analysts, and their individual value adds, in one embodiment of the present invention.

FIG. 3 is a block diagram illustrating one embodiment of a computer implemented system of the present invention for displaying security analyst recommendation information.

FIG. 4 is a screenshot illustrating one embodiment of an analyst scorecard of the present invention.

FIG. 5 is a screenshot illustrating one embodiment of a summary of an individual analyst's ratings for a security that is displayed as a graph or chart.

### DETAILED DESCRIPTION OF THE PREFERRED EMBODIMENTS

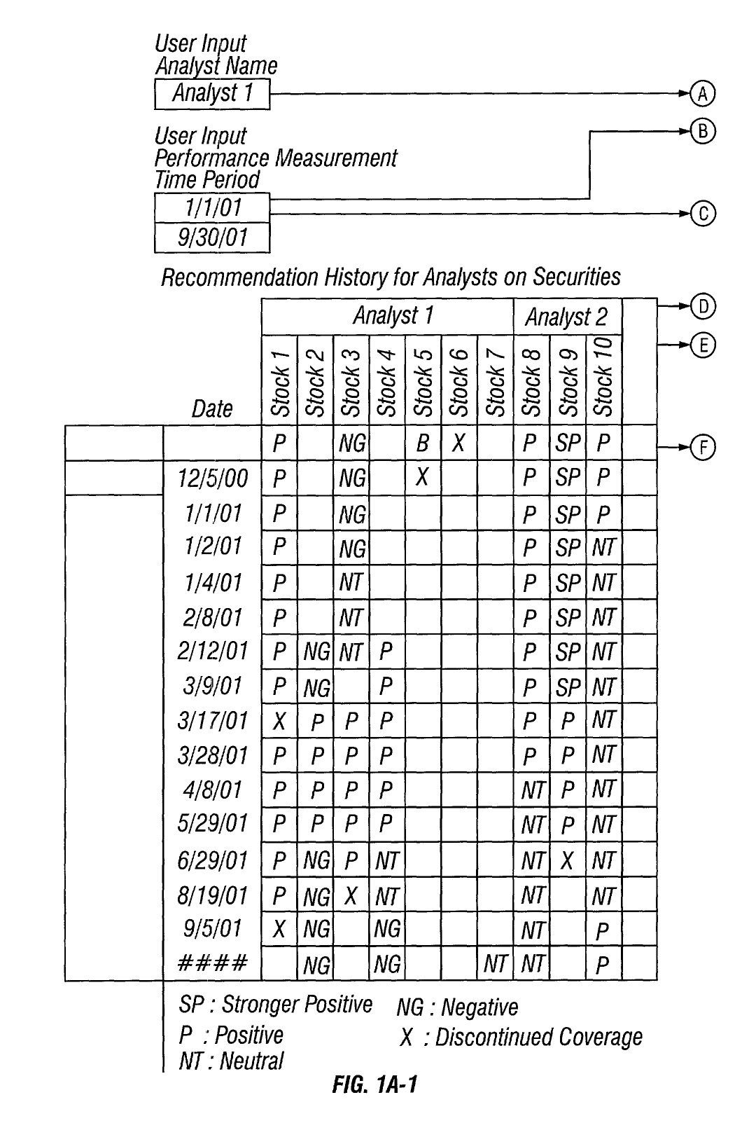

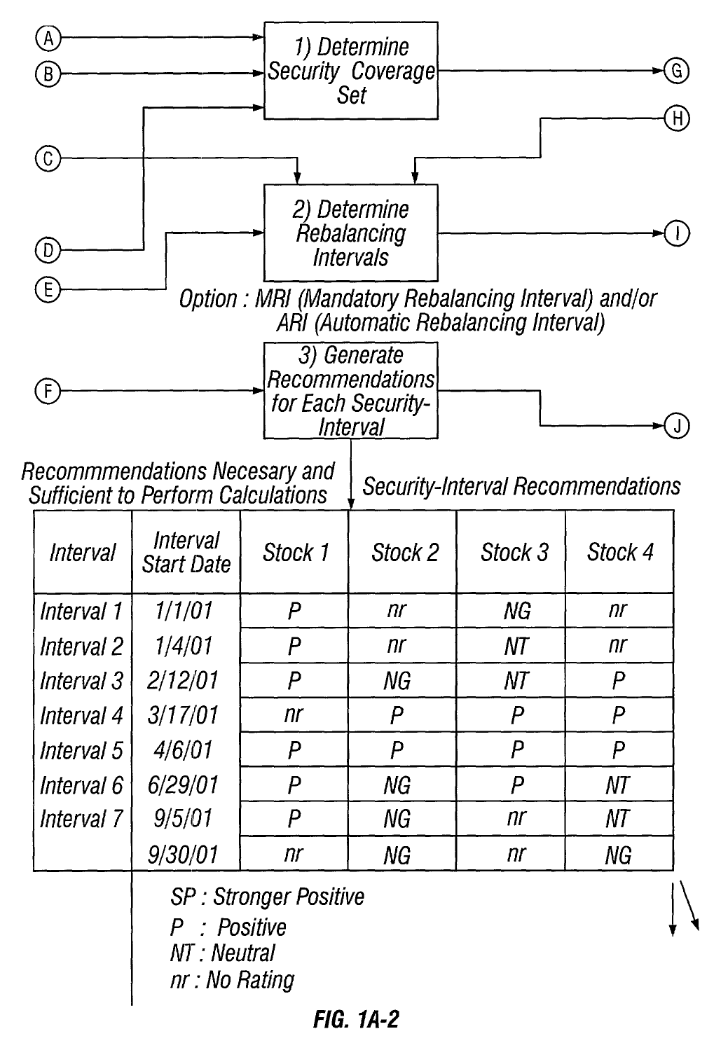

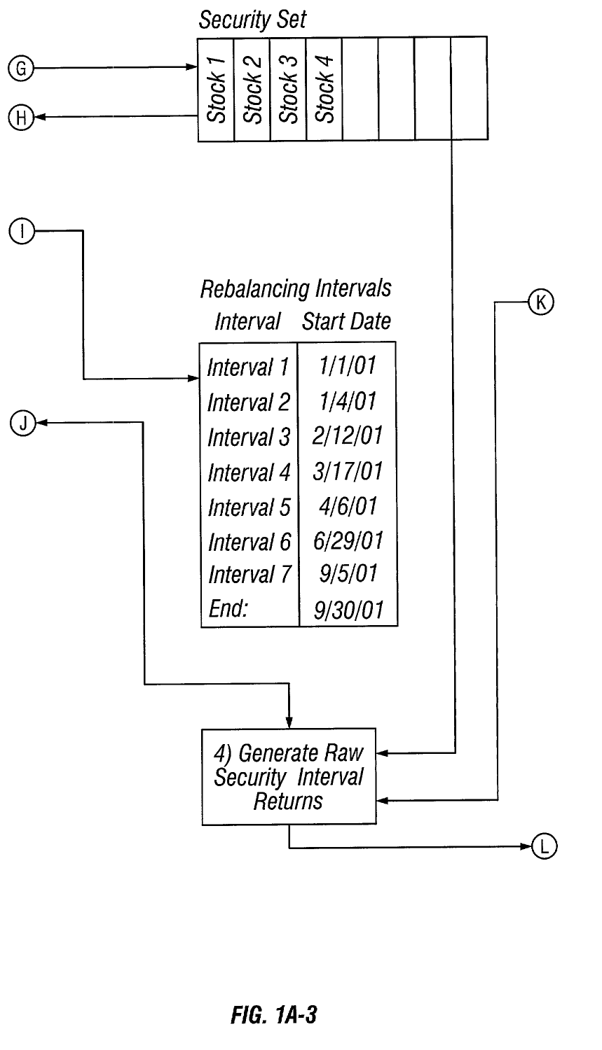

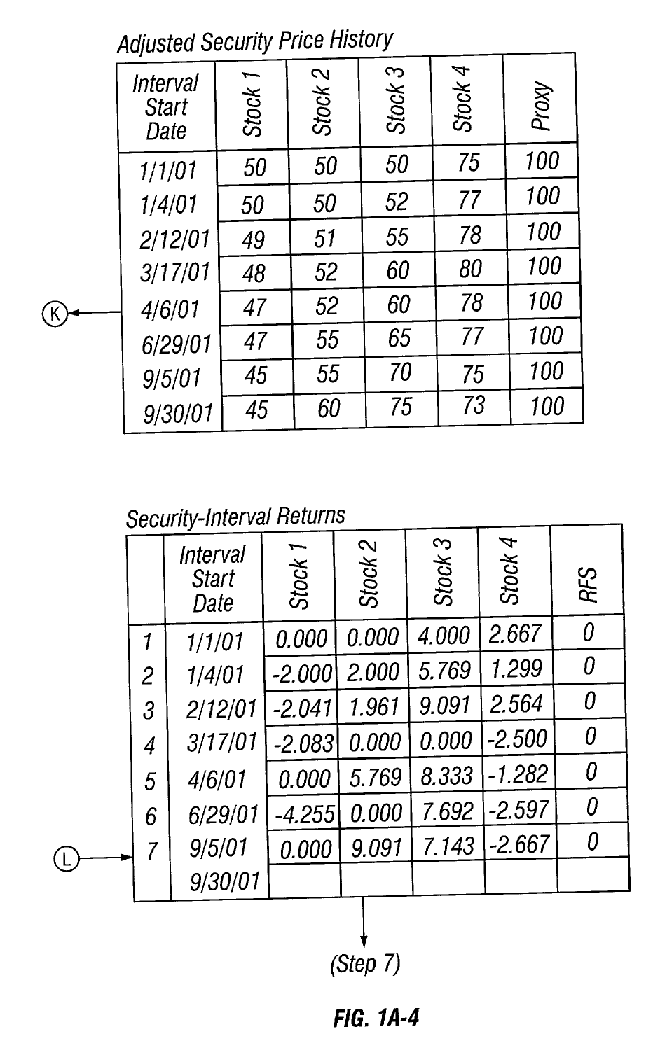

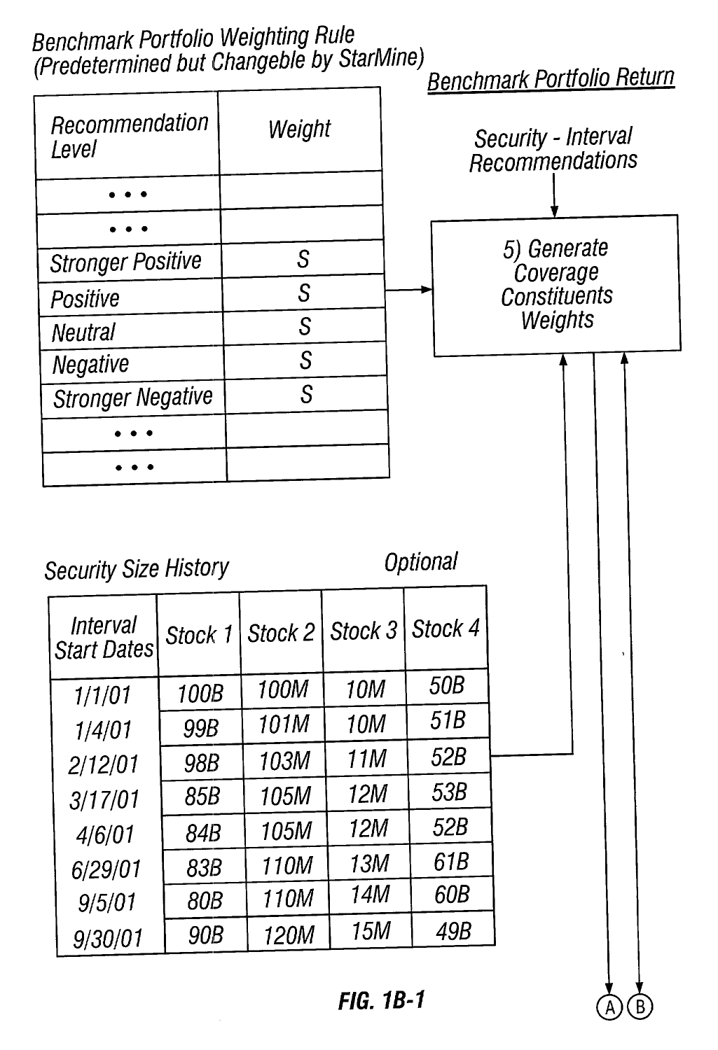

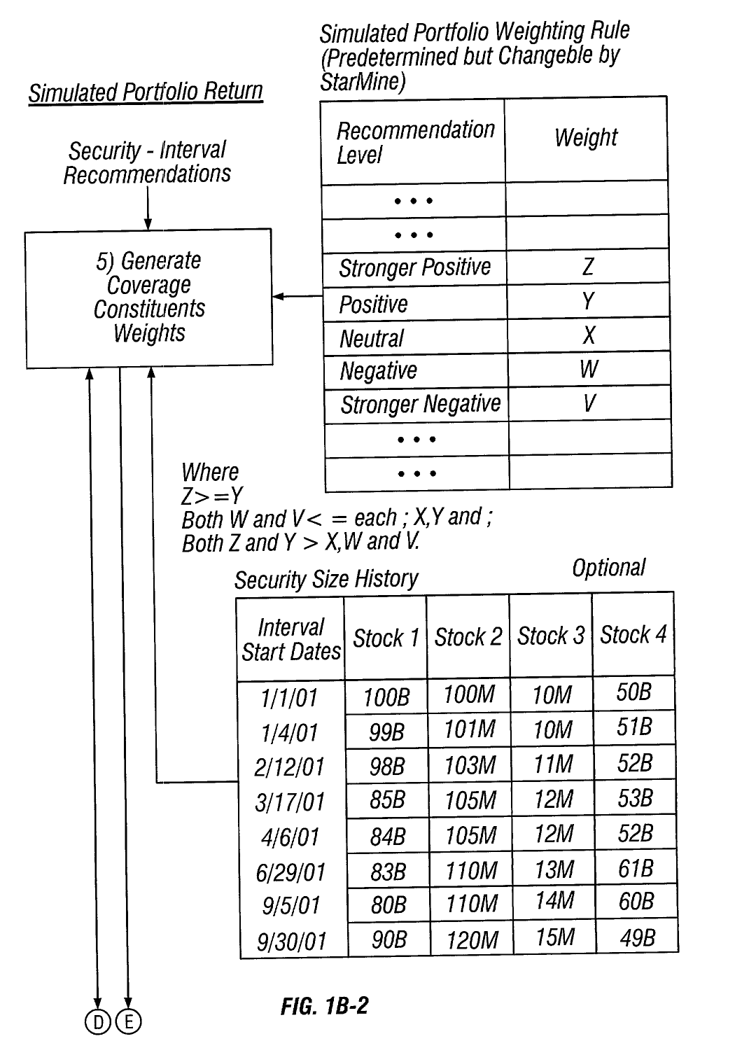

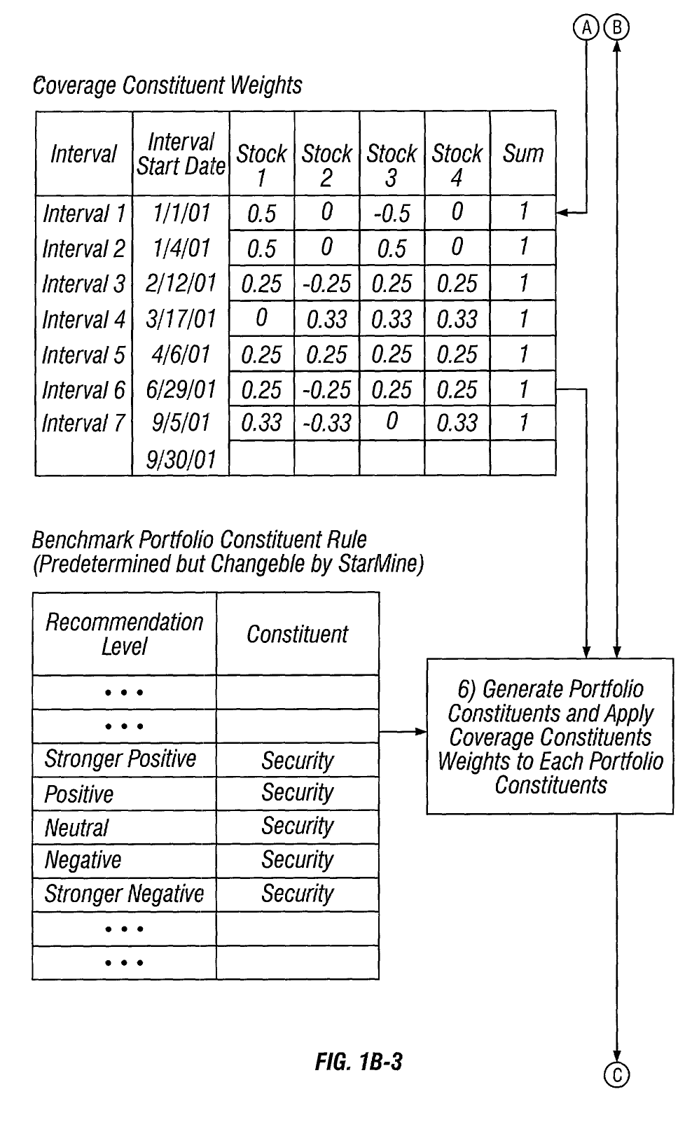

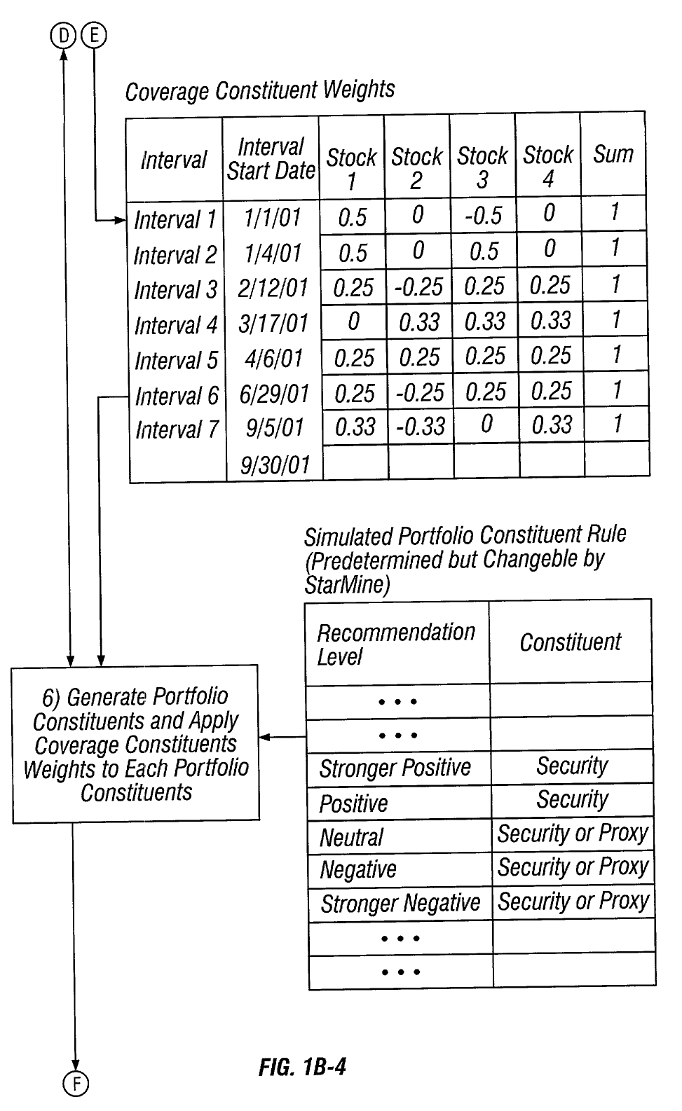

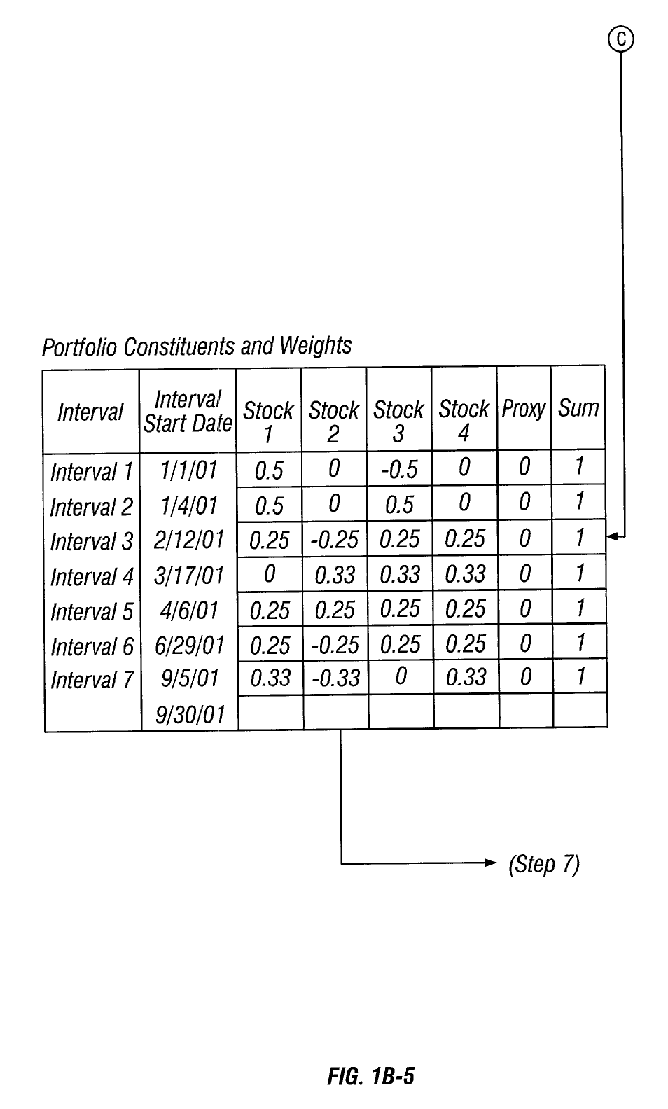

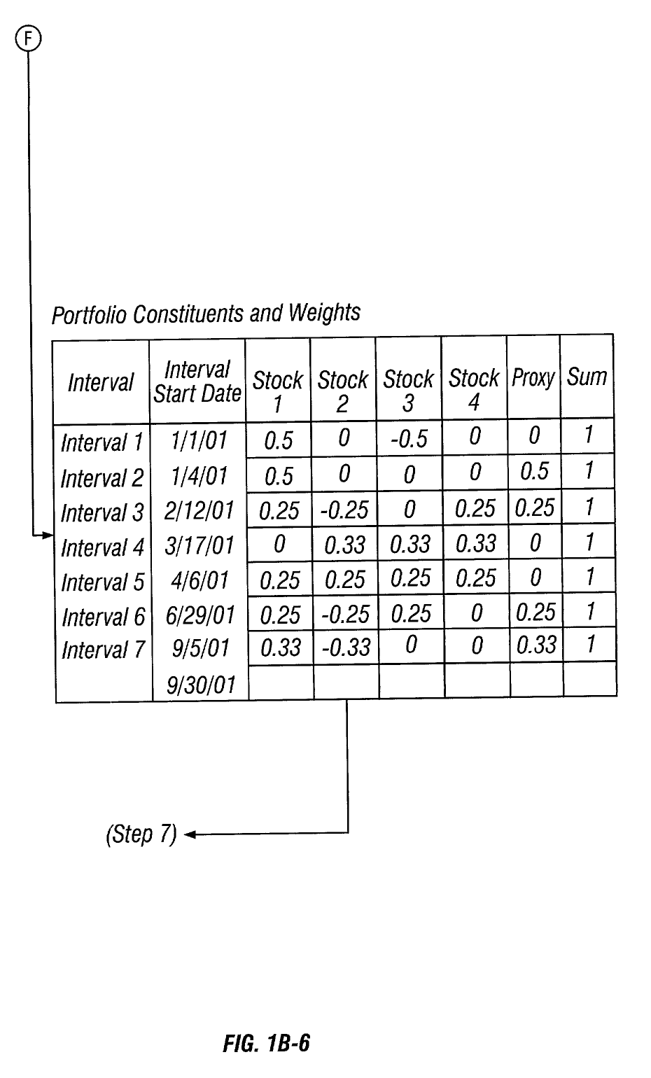

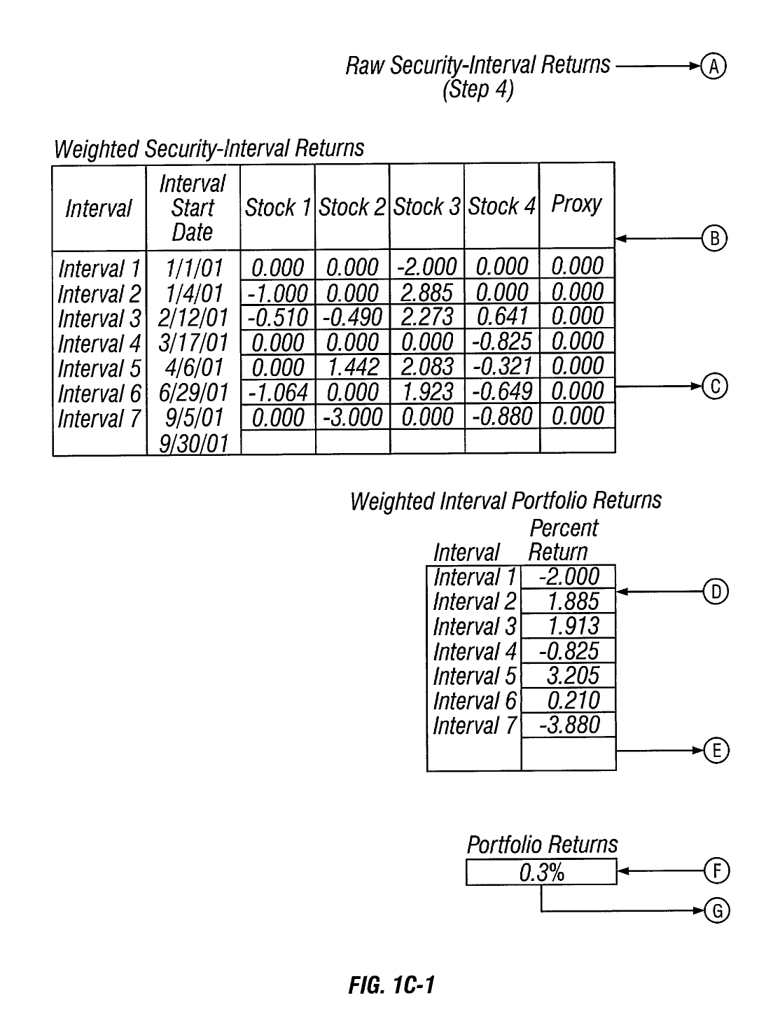

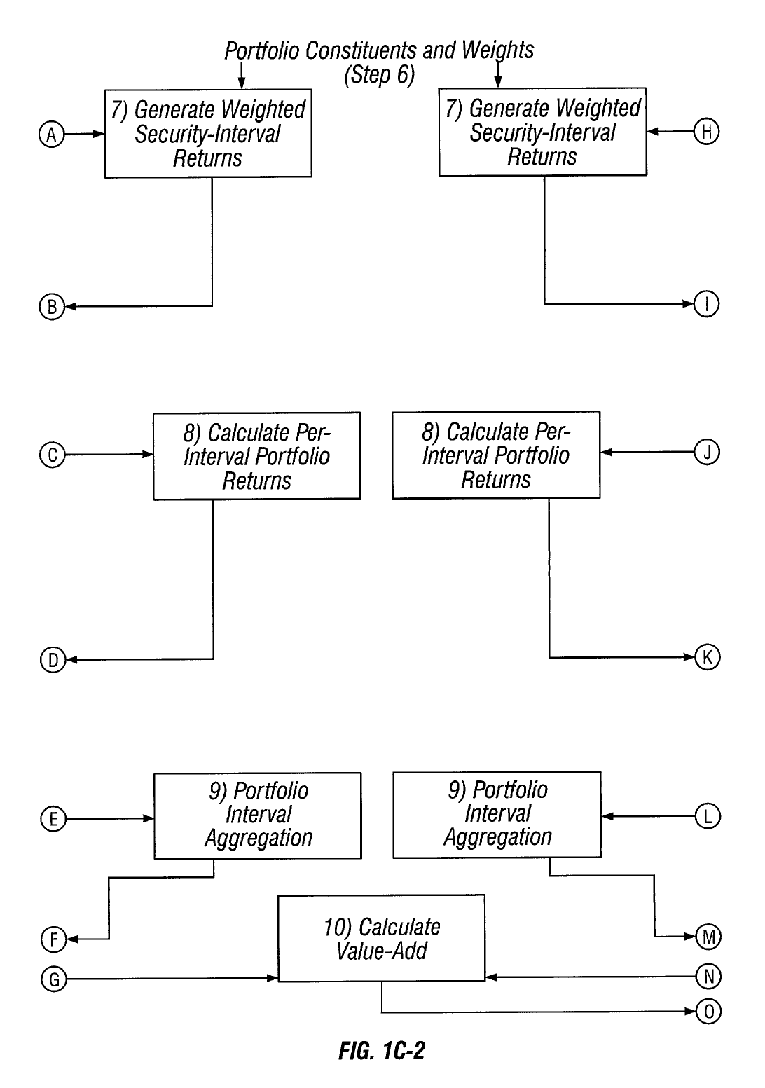

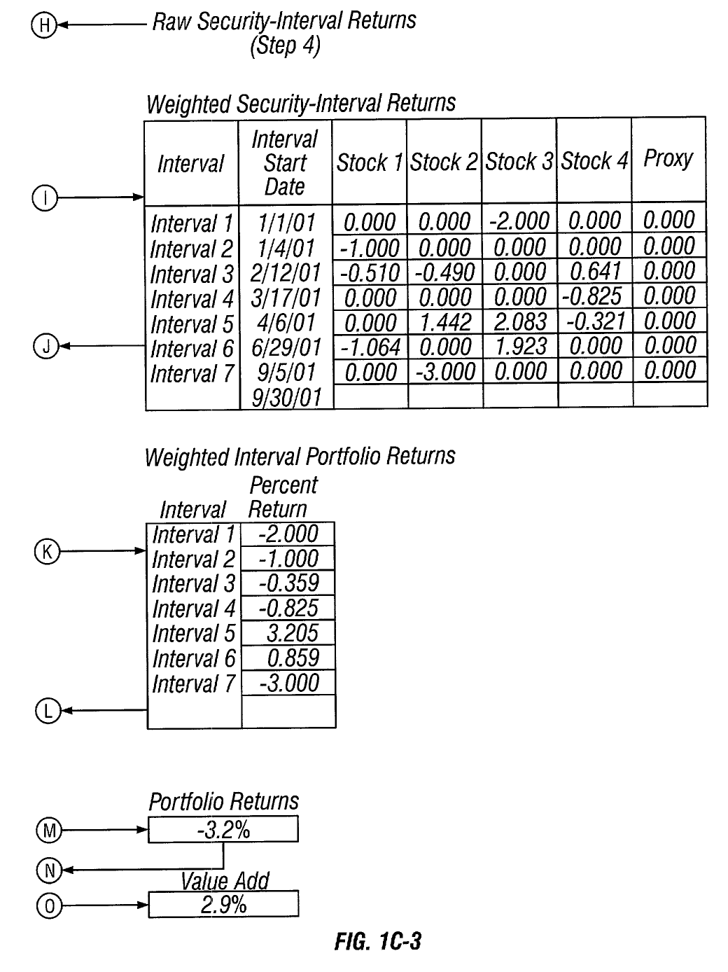

Referring to FIG. 1, one embodiment of the present invention is a method, and a computer implemented system, for use in measuring performance of a security analyst. For purposes of this specification, a security analyst is a person or entity that publishes research reports on securities. In this embodiment, an analyst is selected that covers a set of securities. A performance measurement time period is also selected. A benchmark portfolio return is then calculated. The return of the benchmark portfolio is derived exclusively from a selected set of securities that are included in the set of securities covered by the analyst. The set of securities covered by the analyst includes securities, including but not limited to common stocks and the like, that are assigned to the analyst or that the analyst covers and then publishes research or opinions on those securities that are followed.

The analyst has a securities coverage list that includes those securities on which the analyst has recommendation levels selected from different levels of positive, different levels of negative and can also include a neutral rating. The set of securities covered by the analyst are securities on which the analyst has a recommendation or which are assigned to the analyst. Additionally, the set of securities covered by the analyst includes securities with recommendation levels or no recommendation by the analyst.

A benchmark is used which does not introduce factors not directly related to the analyst coverage. Such factors include securities outside the set of securities covered by the analyst.

These steps are part of a method to then ultimately determine the analyst's securities recommendation performance. A variety of different performance measurement time periods are suitable including but not limited to, calendar month, calendar quarter, calendar year and a 12 month interval of a time period defined by an end date and a duration, a time period defined by a beginning date and an end date, and the like.

In another embodiment of the present invention, a method of measuring performance of a security analyst includes the step of subtracting the return of the benchmark portfolio from a return of a simulated portfolio and multiplying by an adjustment factor. In this embodiment, the return of the benchmark portfolio is again derived exclusively from the selected set of securities that are included in the set of securities covered by the analyst. The simulated portfolio includes constituents and weights that are a function of the analyst's recommendations on the securities in the selected set.

As illustrated in the flowchart of FIG. 1, another embodiment of the present invention provides a method of measuring performance of a security analyst's recommendations by creating the value add and then multiplying the value add by an adjustment factor to provide for comparison of different analysts. The adjustment factor can be, (i) a function of a weighted average of values that are each representative of a time series variation of a price of each security covered by the analyst, (ii) a value that is representative of the variance across returns of the securities covered by the analyst, (iii) a function of a weighted average of values that are each representative of a time series variation of a price of each security covered by the analyst and a variance across returns of the securities covered by the analyst, (iv) a value that is a function of the extent of security coverage during the performance measurement time period, and the like

In another embodiment of the present invention, a method of measuring performance of a security analyst's recommendations creates the value add and then multiplies the value add by an adjustment factor in order to compare different analysts. The adjustment factor can be, (i) a function of a weighted average of values that are each representative of a time series variation of a price of each security covered by the analyst, (ii) a value that is representative of the variance across returns of the securities covered by the analyst, (iii) a function of a weighted average of values that are each representative of a time series variation of a price of each security covered by the analyst and a variance across returns of the securities covered by the analyst, (iv) a value that is a function of the extent of security coverage during the performance measurement time period, and the like. In another embodiment, the value add is multiplied by the adjustment factor in order to create a risk adjusted value add to compare different analysts.

For purposes of this specification, the simulated portfolio is a theoretical holding of securities that can be held by anyone. Securities in the simulated portfolio can change over a course of the performance measurement time period. Additionally, the simulated portfolio has a theoretical monetary value that can change over time. The benchmark portfolio return can be a calculated return that is derived exclusively from a set if securities that are included in the set of securities covered by the analyst.

The return of the simulated portfolio can be calculated on all of the securities covered by the analyst. The weights represent a monetary value of shares assigned to each portfolio constituent when the portfolio is constructed or rebalanced. In one embodiment, securities rated a higher positive level recommendation are assigned a weight greater than or equal to a weight assigned to securities with a lower positive level recommendation. Securities rated with a positive recommendation are assigned a weight greater than or equal to that assigned to securities rated with a non-positive recommendation. Securities rated with a negative level recommendation are assigned a weight less than or equal to securities with a positive level recommendation. Securities rated as a negative level are assigned a weight that is proportional to their return multiplied by a number less than zero.

Simulated portfolio constituents are developed as a function of the analysts recommendations when the simulated portfolio is constructed or re-balanced. When the simulated portfolio is constructed or re-balanced, each security rated by the analyst or a proxy for the security can become a constituent based upon a set of portfolio inclusion rules, and each rule depends on the rating level assigned to the security. In one embodiment, a security with a neutral rating is represented in the portfolio by a proxy. In other embodiments securities with negative level ratings are represented in the portfolio by a proxy. In one embodiment, the proxy for securities rated at one or more of the rating levels is the benchmark portfolio. In one embodiment, the proxy for securities rated at one or more of the rating levels is a risk free security. Examples of suitable risk free securities include but are not limited to a, money market fund, U.S. treasury bill, short term international bond, zero-returning security, and the like.

The weight of each simulated portfolio constituent can be developed as a function of a size weighting and the weight derived from the recommendation level of each security being rated, when the simulated portfolio is constructed or re-balanced. The weight of each benchmark portfolio constituent can be developed as a function of a size weighting of each security in the benchmark portfolio when the benchmark portfolio is constructed or re-balanced.

All of the weights are normalized and when summed together have a value of 1. In one embodiment, the weights are all positive. Each weight has a weighting level. Between two adjacent weighting levels, the difference in the two weights can be a constant multiple. In one instance, a higher recommendation level is assigned to a weight that is a constant multiple, and the constant multiple is greater than a weight assigned to its adjacent recommendation level that has a lower recommendation level.

The size weighting can be a function of market capitalization or of float. The function can include proportional scaling, logarithmic scaling, and the like. Market capitalization is a monetary value of outstanding shares of each security in the portfolio. Float is a monetary value of available shares of each security in the portfolio. Additionally, the available shares is the number of security shares outstanding minus the number of shares unavailable for investing. In one embodiment, at least a portion of the shares unavailable for investing are selected from large private holdings, employee stock ownership plans, corporate cross-owned shares, government holdings, legally restricted shares, and the like.

In another embodiment of the present invention, a method of measuring performance of a security analyst includes selecting an analyst that covers a set of securities as well as a performance measurement time period. A return of a benchmark portfolio is then subtracted from a return of a simulated portfolio and multiplied by an adjustment factor. The return of the benchmark portfolio is derived exclusively from a selected set of securities that are included in the set of securities covered by the analyst. The simulated portfolio has constituents and weights that are a function of the analyst's recommendations on the securities in the selected set. For the simulated return, each security that is rated a negative level relative to a security with a non-negative rating is counted or credited in an amount that is proportional to a security return multiplied by a number less than zero.

The simulated portfolio constituents can be developed as a function of the analysts recommendations when the simulated portfolio is constructed or re-balanced.

In a portfolio calculation, a portfolio return is calculated for each interval between portfolio construction, rebalancing, or termination of the calculation period. During each interval, portfolio constituents and relative weights must be determined. The time period over which a portfolio return is calculated may consist of multiple intervals between construction, rebalancing, or termination of the period.

For a security during a time interval between portfolio construction, rebalancing, or termination of the calculation period,

Rrawsyin=(pfsyin/pisyin−1)

where Rrawsyin is the raw security return for security y over the interval n, pfsyin is the price of the security on the last day of the interval, and pisyin is the price of the security on the last day of the previous interval.

Thereafter, a weighted return can be generated by multiplying, for each security and interval combination in the portfolio constituents and weights, the raw security return by its weighting value. By way of illustration, and without limitation, if a security's weighting value were 1, the security price on the last day of the previous interval were $100, the price on the last day of the interval were $101, the raw return would be (101/100−1)=0.01 and the weighted return would be 0.01.

Weighted returns can be calculated by multiplying, for each security and interval combination, the raw security return by the weighting value. A weighted portfolio return is produced for each interval by combining all of the weighted security returns for each interval.

A portfolio return can be generated for each interval between portfolio construction, rebalancing, or termination of the calculation period, by dividing the sum of the weighted returns of each security during the interval by the sum of the absolute value of the weighting factors of each security during the interval.

Rpi1=(WRs1i1+WRs2i1+ . . . WRsyi1)/(absolute value (ws1i1)+absolute value (ws2i1)+ . . . absolute value (wsyi1))

50 Where Rpi1 is the portfolio return for interval 1, WRsni1 is the Weighted return for security n during interval 1, and wsni1 is the weighting factor for security n during interval 1. Interval 1 represents any time interval between the time of construction or rebalancing and the time of the subsequent rebalancing or termination of the calculation period.

WRs1i1=Rraws1i1*ws1i1, where WRs1i1 is the weighted return of security 1 during interval 1, Rraws1i1 is the raw return of security 1 during interval 1, and ws1i1 is the weighting factor for security 1 during interval 1. The weighting factor for security 1 represents the weight of that constituent.

A portfolio return is generated for the period by combining all portfolio interval returns. This creates a portfolio return for the entire time period that is a benchmark portfolio return.

RT=((1+Rp1)*(1+Rpi2) . . . *(1+Rpin))−1

51 Where RT is the portfolio return for the entire evaluation time period and Rpin is the interval portfolio return for the n'th interval.

The weight of each simulated portfolio constituent can be developed as a function of a size weighting, The weight of each benchmark portfolio constituent is developed as a function of a size weighting of each security in the benchmark portfolio when the benchmark portfolio is constructed or rebalanced. Size weighting can be a function of market capitalization or float. The function can include proportional scaling, logarithmic scaling, scaling proportional to a power function, and the like.

Another embodiment of the present invention measures performance of a security analyst's recommendations creates the value add. The value add is determined by subtracting a return of a benchmark portfolio from a return of a simulated portfolio return and multiply by an adjustment factor. The return of the benchmark portfolio is derived exclusively from a selected set of securities that are included in the set of securities covered by the analyst. The simulated portfolio includes constituents and weights that are a function of the analyst's recommendations on the securities in the selected set. A performance rating of the analyst is provided and displayed.

Value add can then be utilized to create, an individual scorecard for an analyst, a rank order of analysts, an average value add for a group of analysts and the like. The group can be defined from a geographic location, a firm, an industry, a client and the like.

In another embodiment of the present invention, a performance measurement time period is selected that is divided into intervals. A value add is created for each interval. A portfolio statistic is created for each interval. In one instance, an average value add over all of the intervals is created. An average portfolio statistic is then created by averaging portfolio statistics of all of the intervals. The average value add is divided by the average portfolio statistic to create a risk adjusted value add. In another instance, a ratio is created of value add divided by portfolio statistic for at least one interval. The intervals can be any time period including but not limited to monthly.

The portfolio statistic can be a value that is representative of a variation during an interval of returns for all securities covered by the analyst. This value that is representative of the variation can be equal to a standard deviation of the interval returns of all securities covered by the analyst.

Referring now to FIG. 2, a screenshot illustrates the listing and displaying of individual analysts, and their individual value adds. FIG. 2 illustrates the further usage of the value add and includes, listing and displaying individual analysts and their individual value adds, calculating a median value add of a group of analysts, determining a percent of analysts within a group that have a value add above a selected level, comparing a value add of one analyst to value adds of a group of analysts, comparing a value add of an analyst to a value add average of analysts in a group, and the like.

The present invention also provides a computer implemented system 110 for displaying security analyst recommendation information as illustrated in FIG. 3. System 110 includes a database 112. In one embodiment, database 112 has information on an overall analyst score and includes the value add, a user interface 114 including a plurality of selectable user inputs to enable a user to display analyst security recommendation information, an input device 116 that is operable by a user, and a display 118 for displaying at least one output of security analyst information according to the selected user inputs, a memory 120 for storing a variety of different information including but not limited to one or more of an analyst's benchmark portfolio return, simulated portfolio return, value add, returns of securities during time periods over which the analyst had specific rating levels on them within an overall performance measurement time period, and the like, and a microprocessor 122. In one embodiment, display 118 simultaneously displays at least one output of the analyst's securities recommendation performance and an estimates performance for a plurality of securities listed on a securities estimates list of the analyst.

At least one output can include a performance rating of the analyst relative to the analyst's securities recommendation performance. A variety of different user inputs can be provided including but not limited to inputs that enable a user to, select whether the portfolio calculations are sized weighted or non-size-weighted, select securities for inclusion in the performance calculation, selection of the recommendation performance measurement time period, selection of estimate performance time period, and the like.

As shown in FIG. 4, a sample of an analyst scorecard with performance ratings, tables and the like are displayed. In various embodiments, the scorecard can include, a summary of one or more user outputs, the value add and an overall relative estimating accuracy score for the analyst, analyst benchmark portfolio return, simulated portfolio return, analyst securities recommendation performance based on the analyst's security ratings, a summary of the user outputs from system 110, and the like.

System 110 can provide a variety of different user outputs including but not limited to, a calculated return for selected securities, a calculated return for selected securities while under each rating level, a performance rating of the analyst relative to the analyst's securities recommendation performance, and the like. All or a portion of the user outputs can include a summary row that provides cumulative information from individual rows in the table. All or a portion of the summary row can include a portfolio return, an average return and overall relative estimating accuracy score for the securities displayed in the table.

It will be appreciated that the scorecard can include a variety of information and displayed in different formats including but not limited to an overall analyst performance score, a summary by a security table, a summary by a security group table, and the like.

In another embodiment of the present invention, display 110 can provide a summary of an individual analyst's securities recommendation performance that is displayable as an output in a variety of different forms including but not limited to a, summary by security table, summary by security group table, an analyst overall score and the like.

As illustrated in FIG. 4, the summary by security table can include rows and columns that are interchangeable. Each security rated by the analyst during the selected time period can be listed in the summary by security table. User outputs can be provided in the summary by security table. In one embodiment, the user outputs can be performance results of each security of the analyst's securities ratings that are then summarized and displayed as an output as a single row and a plurality of columns with information.

By way of illustration, and without limitation, examples of information in the columns can include but is not limited to, security group classification, ticker symbol, company name, security size, security return, securities recommendation coverage, return under each rating level, coverage percent for earnings estimating, relative estimating accuracy score for estimates, relative estimating accuracy star rating or rank for estimates,

FIG. 4 also illustrates a summary by security group table with rows and columns that are interchangeable. Each group of securities rated by the analyst during the selected time period can be listed in the summary by security group table. User outputs can be provided in the summary by security group table. In one embodiment, the user outputs can be performance results of each security group of the analyst's securities ratings that are then summarized and displayed as an output as a single row and a plurality of columns with information, and the like.

By way of illustration, and without limitation, examples of information in the columns can include but is not limited to, security group name abbreviation, security group name, number of stocks in a security group, an average return of securities in a security group, number of securities in a security group covered by the analyst's recommendations, the analyst's simulated return within a security group, the analyst's excess return for the security group, the analyst's recommendation performance rank relative to other analysts that cover a security group, number of securities in a security group covered by the analyst's estimates, accuracy score of the analyst for a security group, the analyst's estimate performance rank relative to other analysts that cover a security group, and the like.

Each row of the summary by security table can include an analyst performance for an individual security. A variety of different columns can be provided including but not limited to columns that, enables a user to select securities for aggregation, an indication of continued coverage of a selected security by the analyst, an indication of a security group classification, an indication of a security ticker symbol, names of securities, country code or name for the exchange on which each security is traded, country code or name representing the country in which the company which the security represents is located, a security size where size is a function of market capitalization or float, a return of a security over a selected performance measurement time period, information relative to a percent of a selected performance measurement time period that an analyst had a recommendation for a security, analyst rating, return of a security under each type of analyst rating, relative estimating accuracy performance score for a security, table with a summary of individual analyst's security recommendation performance for a plurality of analyst, and the like.

System 110 can provide a variety of user inputs, including but not limited to selection of, analyst name, performance measurement time period, whether the portfolio calculations are sized weighted or non-weighted, securities for inclusion in the performance calculation.

In one embodiment of the present invention, a summary by security group table is provided that can displayed as rows and columns of desired information. The group can be, securities in the same industry, securities in the same geographic region, or a user-defined group of securities. Performance results of the analyst's securities ratings of securities in a same security group can then be summarized and displayed as an output in a single row.

In another embodiment of the present invention, illustrated in FIG. 5, system 110 can provide a summary of an individual analyst's ratings for a security that can be displayable as a graph or chart 124 with at least two time series plots 126 and 128 respectively. One of the time series plots 126 or 128 is representative of the analyst's recommendations over time. Analyst recommendations are plotted against a vertical axis 130 which is representative of recommendation levels, and a horizontal axis 132 that is representative of time. The other time series plot 126 or 128 is representative of a price for the security over time; where the price for the security is plotted against another vertical axis 134 that is representative of security price and horizontal axis 132. It will be appreciated that vertical and horizontal axes 130 and 132 are interchangeable.

In one embodiment of system 110, the analyst's rating level for a security is represented as a series of points or a horizontal line (collectively a plotted line 136) at a level that is representative of the analyst's rating level. Plotted line 136 continues until a point in time 136 where a change occurs. Suitable changes include but are not limited to an increase in a recommendation, a decrease in a recommendation level, a discontinuation of recommendation level, and the like. When the change is, (i) a discontinuation of the recommendation on the stock, and plotted line 136 terminates at a point on graph 124 that is representative of the time that the recommendation is discontinued, or (ii) is represented during the period without recommendation, then plotted line 136 can be a line of a different color, a line type, or any other representative that makes it distinguished, over subsequent time intervals

Plotted line 136 during the period without recommendation continues until the analyst reinstates coverage for the security. A new issued recommendation is represented by a line color or type that is the same as the line color or type that represented the recommendation level for the period prior to the time without recommendation. The level of the plot corresponds to the recommendation level of the newly issued recommendation.

The change can be from one recommendation level to a different recommendation level. The plotted recommendation level can be plotted as a stairstep to represent a change in recommendation level as illustrated in FIG. 5.

In one embodiment, a reiteration of the recommendation level for the security at the same recommendation level is shown as a data marker on the plot at the time of a reiteration.

Chart 124 can be configurable to provide an overlay or underlay of one or more of the following, (i) a highest recommendation level of a plurality of analysts, (ii) a lowest recommendation level of the plurality of analysts or (iii) an average recommendation level of the plurality of analysts.

In various embodiments, system 110 can provide that a change in the highest or lowest recommendation level of the analysts that can be plotted as a stairstep to represent the change in recommendation level.

The time period for the chart display can be selectable by the user. One or more tables can be provided that summarize data contained in chart 124. Such tables can be displayed in conjunction with chart 124 and include information or each recommendation level selected from one or more of, (i) recommendation level, (ii) initiation date, (iii) termination date, (iv) amount of time active, (v) price at the time of initiation, (vi) price at time of termination or (vii)percent return over the duration of the recommendation. Further, such tables can provide summarizing data contained chart 124 that are displayed in conjunction with chart 124 and can include information selected from one or more of the following, (i) date of interest, which can include the beginning of the chart period, (ii) the end of the chart period, (iii) the beginning of any month or year or (iv) the date and the price level of the security.

The present invention also is a computer-readable medium imprinted with a computer program that contains instruction steps. Upon installation of computer program in a general purpose computer, any of the methods of the present invention are performed.

The methods and systems of the present invention can be utilized for a variety of different uses and applications such as (i) to monitor security analysts, (ii) monitor performance of security analysts, (iii) tie compensation of security analysts to performance, (iii) to provide quality control of security analysts, (iv) for compliance purposes with government and/or regulatory agencies rules and regulations, (v) compliance with employer standards, rules and conditions, (vi) marketing purposes, and the like.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A computer implemented system for displaying security analyst recommendation information, comprising:
a database including information on an overall analyst score which includes a value add that is obtained by subtracting a return of a benchmark portfolio from a return of a simulated portfolio return, the return of the benchmark portfolio being derived exclusively from a selected set of securities that are included in a set of securities covered by the analyst, the simulated portfolio including constituents and weights that are a function of the analyst's recommendations on the securities in the selected set;
a user interface including a plurality of selectable user inputs to enable a user to display analyst security recommendation information;
an input device operable by a user; and
a display for displaying at least one output of a security analyst information according to the selected user inputs.

2. The system of claim 1, wherein the at least one output includes a performance rating of the analyst relative to the analyst's securities recommendation performance.

3. The system of claim 1, wherein at least one user input of the plurality of selectable user inputs includes selection of whether the portfolio calculations are sized weighted or non-size-weighted.

4. The system of claim 1, wherein at least one user input of the plurality of selectable user inputs includes selection of securities for inclusion in the performance calculation.

5. The system of claim 4, wherein the selection of securities for inclusion in the performance calculation is a group of securities.

6. The system of claim 5, wherein the group includes securities in at least one of the same industry, securities in the same geographic region, and a user-defined group of securities.

7. The system of claim 2, wherein the performance rating of the analyst is displayed on an analyst scorecard of performance of the analyst's securities recommendation performance based on the analyst's security ratings.

8. The system of claim 7, wherein the scorecard includes a summary of a plurality of user outputs.

9. The system of claim 7, wherein the scorecard includes a value add and a relative estimating accuracy score for the analyst.

10. The system of claim 7, wherein the scorecard includes at least one of an analyst's benchmark portfolio return, simulated portfolio return, value-add and a measure of an analyst's relative estimating accuracy.

11. The system of claim 1, wherein security analyst information includes a value add.

12. The system of claim 1, further comprising:
a memory for storing an analyst's benchmark portfolio return, simulated portfolio return and value add; and
a microprocessor.

13. The system of claim 1, wherein the performance rating of the analyst is an analyst scorecard that includes at least one of an overall analyst performance score, a summary by a security table and a summary by a security group table.

14. The system of claim 13, wherein the summary by security table is a two dimensional table including for each security the return of the security for each recommendation level that the analyst had on the security.

15. The system of claim 1, further comprising:
a memory for storing an analyst's benchmark portfolio return, simulated portfolio return and value add; and
a microprocessor.

16. A computer implemented system for displaying security analyst recommendation information, comprising:
a database including information on an analyst's securities recommendation performance for a plurality of securities listed on a securities recommendation list;
a user interface including a plurality of selectable user inputs to enable a user to display analyst security recommendation information;
a user interface including a plurality of selectable user inputs to enable the user to display analyst security recommendation information;
an input device operable by a user; and
a display that simultaneously displays at least one output of the analyst's securities recommendation performance and an estimates performance for a plurality of securities listed on a securities estimates list of the analyst.

17. The system of claim 16, wherein at least a portion of the securities in the plurality of recommendation performance securities is included in at least a portion of the plurality of estimates performance securities.

18. A computer implemented system for displaying security analyst recommendation information, comprising:
a database including information on at least a portion of securities covered by an analyst,
a user interface including a plurality of selectable user inputs to enable a user to display analyst security recommendation information;
an input device operable by a user; and
a display for displaying at least one output of a security analyst information according to the selected user inputs;
wherein the system provides a summary of an individual analyst's securities recommendation performance that is displayable as an output in the form of at least one of a summary by security table, a summary by security group table or an analyst overall score.

19. The system of claim 18, wherein the summary by security table includes a plurality of rows and columns.

20. The system of claim 19, wherein the rows and columns are interchangeable.

21. The system of claim 18, wherein each security rated by the analyst during the selected time period is listed in the summary by security table.

22. The system of claim 18, wherein a plurality of user outputs are provided in the summary by security table, and at least a portion of the plurality of user outputs includes performance results of each security of the analyst's securities ratings is summarized and displayed as an output as a single row and a plurality of columns with information selected from security group classification, ticker symbol, company name, security size, security return, securities recommendation coverage, return under each rating level, coverage percent for earnings estimating, relative estimating accuracy performance score for estimates, and relative estimating accuracy rating or rank for estimates.

23. The system of claim 19, wherein each row of the summary by security table includes an analyst performance for an individual security.

24. The system of claim 19, wherein at least one column of the plurality of columns enable a user to select of securities to be included in an aggregation.

25. The system of claim 19, wherein at least one column of the plurality of columns provide an indication of continued coverage of a selected security by the analyst.

26. The system of claim 19, wherein at least one column of the plurality of columns provide an indication of a security group classification.

27. The system of claim 19, wherein at least one column of the plurality of columns provide an indication of a security ticker symbol.

28. The system of claim 19, wherein at least one column of the plurality of columns provides a name of a security.

29. The system of claim 19, wherein at least one column of the plurality of columns provides country code or name for the exchange on which each security is traded.

30. The system of claim 19, wherein at least one column of the plurality of columns provide country code or name representing the country in which the company which the security represents is located.

31. The system of claim 19, wherein one column of the plurality of columns provides a security size, wherein size is a function of market capitalization or float.

32. The system of claim 19, wherein at least one column of the plurality of columns provide a return of a security over a selected performance measurement time period.

33. The system of claim 19, wherein at least one column of the plurality of columns provides information relative to a percent of a selected performance measurement time period that an analyst covered the security, wherein securities covered by the analyst are securities on which the analyst has a recommendation or which are assigned to the analyst.

34. The system of claim 19, wherein at least one column of the plurality of columns is an analyst rating column.

35. The system of claim 19, wherein at least one column of the plurality of columns is provided for a return of a security under each level of an analyst rating.

36. The system of claim 19, wherein at least one column of the plurality of columns provides a relative estimating accuracy performance score for the analyst on the security.

37. The system of claim 18, wherein the system provides a table with a summary of individual analyst's security recommendation performance for a plurality of analyst.

38. The system of claim 18, wherein the at least one output includes a performance rating of the analyst relative to the analyst's securities recommendation performance.

39. The system of claim 18, wherein at least one of a user input includes selection of an analyst name.

40. The system of claim 18, wherein at least one of a user input includes selection of a performance measurement time period.

41. The system of claim 18, wherein at least one of a user input includes selection of whether the portfolio calculations are size weighted or non-weighted.

42. The system of claim 18, wherein at least one of a user input includes selection of securities for inclusion in a calculation of the securities recommendation performance.

43. The system of claim 18, wherein the at least one user output includes a return of the security during a performance measurement time period.

44. The system of claim 43, wherein the at least one of a user input includes selection of a performance measurement time period.

45. The system of claim 18, wherein the performance rating of the analyst is displayed in an analyst scorecard of performance of the analyst's securities recommendation performance based on the analyst's security ratings.

46. The system of claim 45, wherein the scorecard includes a summary of a plurality of user outputs.

47. The system of claim 45, wherein the scorecard includes a value add and a relative estimating accuracy performance for the analyst.

48. The system of claim 45, wherein the scorecard includes at least one of an analyst's benchmark portfolio return, simulated portfolio return, value-add and a relative estimating accuracy performance score.

49. The system of claim 19, wherein a plurality of user outputs are provided, and at least a portion of the plurality of user outputs includes one or more summary rows that provide aggregate information from a plurality of individual rows in the table.

50. The system of claim 49, wherein each summary row includes at least one of a portfolio return, average return and overall relative estimating accuracy score for the securities displayed in the table.

51. The system of claim 18, wherein the summary by security group table includes a plurality of rows and columns.

52. The system of claim 51, wherein the rows and columns are interchangeable.

53. The system of claim 51, wherein the group includes securities in at least one of the same industry, securities in the same geographic region, and a user-defined group of securities.

54. The system of claim 51, wherein performance results of the analyst's securities ratings of securities in a same security group is summarized and displayed as an output in the form of a single row.

55. The system of claim 51, wherein at least a portion of the columns include a security group name abbreviation, a security group name, a number of stocks in a security group, an average return of securities in a security group, a number of securities in a security group covered by the analyst's recommendations, the analyst's simulated return within a security group, the analyst's excess return over a benchmark return for the security group, the analyst's recommendation performance rank relative to other analysts that cover a security group, a number of securities in a security group covered by the analyst's estimates, a relative estimating accuracy performance score of the analyst for a security group, or the analyst's estimate performance rank relative to other analysts that cover a security group.

56. A computer implemented system for displaying security analyst recommendation information, comprising:
a database including information on at least a portion of securities covered by an analyst,
a user interface including a plurality of selectable user inputs to enable a user to display analyst security recommendation information;
an input device operable by a user;
a display for displaying at least one output of a security analyst information according to the selected user inputs; and
wherein the system provides a summary of an individual analyst's ratings for a security that is displayable as a chart with at least first and second time series plots, the first time series plot being representative of the analyst's recommendations over time with the analyst's recommendations plotted against a vertical axis that is representative of recommendation levels and a horizontal axis that is representative of time, and the second time series plots being representative of a price for the security over time with the price for the security plotted against another vertical axis that is representative of security price and the horizontal axis is representative of time.

57. The system of claim 56, wherein the analyst's rating level for a security is represented as a series of points representative of the analyst's rating level.

58. The system of claim 57, wherein the series of points continues until an occurrence of a change.

59. The system of claim 57, wherein the series of points is a line.

60. The system of claim 58, wherein the change is a discontinuation of a recommendation of a stock.

61. The system of claim 60, wherein the series of points begins again when there is a re-continuation of the recommendation of the stock.

62. The system of claim 58, wherein the change is a change of a recommendation level to a different recommendation level

63. The system of claim 57, wherein re-continuation of the recommendation is shown as a data marker.

64. The system of claim 56, wherein the vertical and horizontal axes are interchangeable.

65. The system of claim 56, wherein the chart is configurable to provide an overlay or underlay of one or more of, a highest recommendation level of a plurality of analysts, a lowest recommendation level of the plurality of analysts, and an average recommendation level of the plurality of analysts.

66. The system of claim 65, wherein a change in the highest or lowest recommendation level of a plurality of analysts is plotted as a stairstep to represent a change in recommendation level.

67. The system of claim 56, wherein the time period for the chart display is selectable by the user.

68. The system of claim 56, wherein at least one table with summarizing data is displayed with the chart.

69. The system of claim 68, wherein the summarizing data includes information selected from, a recommendation level, an initiation date of recommendation, a termination date of recommendation, an amount of time active relative to recommendation, a price at a time of initiation of recommendation, a price at a time of termination of recommendation, and a percent return over a duration of the recommendation.

70. The system of claim 68, wherein the summarizing data includes information selected from, a beginning of a chart period, an end of the chart period, a beginning date of a selected month, a beginning date of a selected year, and a date and price level of a security.

71. A computer implemented system for measuring an analyst's security recommendation performance, comprising:
means for providing information on at least a portion of securities covered by an analyst;
means for providing a plurality of selectable user inputs to enable a user to display analyst security recommendation information;
means for providing input by a user; and means for displaying at least one output of a security analyst information according to the selected user inputs.
